(19) United States
(12) Patent Application Publication
(10) Pub. No.: US 2026/0367861 A1
(43) Pub. Date: Nov. 19, 2026

(54) AUDIO PROCESSING

(71) Applicant: Cirrus Logic International Semiconductor Ltd., Edinburgh (GB)

(72) Inventors: Rick HUANG, Taipei (TW); David T. WANG, Taipei (TW); David PEYER, Austin, TX (US)

(73) Assignee: Cirrus Logic International Semiconductor Ltd., Edinburgh (GB)

(21) Appl. No.: 19/207,634

(22) Filed: May 14, 2025

(51) Int. Cl. G06F 3/16

(52) U.S. Cl. CPC G06F 3/162; G06F 3/165

(57) ABSTRACT

A system, comprising: main circuitry, comprising: a central processor; memory comprising software instructions which when executed by the central processor cause the central processor to: detect a status of an application to be executed on the central processor; output a first audio signal; output a hardware control signal in dependence on the status; audio processing circuitry configured to: receive the first audio signal; apply first hardware audio effects to the first audio signal to generate a first hardware processed audio signal; and output an output audio signal derived from the first hardware processed audio signal to an output audio transducer; and a controller configured to dynamically adjust the first hardware audio effects applied to the first audio signal based on the hardware control signal.

### TECHNICAL FIELD

The present disclosure relates to systems and methods of audio processing.

### BACKGROUND

Audio processing in personal computers (PCs) is typically implemented primarily in software. For example, in operating systems such as the Windows Operating System from Microsoft Corporation, audio processing is implemented using audio processing objects (APOs). An APO is an object that contains an algorithm which provides a specific digital signal processing (DSP) effect (an “audio effect”). APOs typically runs on a central processing unit (CPU) of a PC, or a DSP integrated into a system on chip (SoC) of the PC. APOs may compensate for speaker and/or acoustic design characteristics or provide for improved and/or optimized audio output from the PC. APOs may also detect which applications are running in an operating system and adjust audio effects accordingly.

Reliance on dedicated APOs to achieve quality audio effects for PCs leads to several problems. Because APO software can be of considerable size, PC users and or information technology (IT) departments can view APOs as undesirable or unnecessary (so-called “bloatware”), and delete such software from the PCs or not include them in a corporate software image. As a result, PC original equipment manufacturers (OEMs) cannot be confident that PCs which they manufacture operate in the manner they intended, potentially leading to negative customer experience.

### SUMMARY

Embodiments of the present disclosure aim to address or at least ameliorate one or more of the above issues by providing a system architecture for a PC which certain audio processing tasks are handled by a kernel mode driver operating in a kernel of an operating system. The audio path is defined in system management firmware which is securely signed and stored in memory of the PC. Removal of a software APO or an associated audio driver leads to corruption of the audio path such that audio no longer functions on the PC. In preventing or deterring removal of the APO by a user, quality of audio output from the PC can be ensured.

According to an aspect of the disclosure, there is provided a system, comprising: main circuitry, comprising: a central processor; memory comprising software instructions which when executed by the central processor cause the central processor to: detect a status of an application to be executed on the central processor; output a first audio signal; output a hardware control signal in dependence on the status; audio processing circuitry configured to: receive the first audio signal; apply first hardware audio effects to the first audio signal to generate a first hardware processed audio signal; and output an output audio signal derived from the first hardware processed audio signal to an output audio transducer; and a controller configured to dynamically adjust the first hardware audio effects applied to the first audio signal based on the hardware control signal.

The controller may comprise a software driver executed on the central processor.

The controller may be implemented in hardware by the audio processing circuitry.

Detecting the status of the application may be performed by a driver executed by the central processor. The driver may be a kernel mode device driver executed in an operating system kernel.

The status of the application may comprises one or more of: loading or unloading of the application into the memory; creation or deletion of an application process associated with the application; one or more settings of the main circuitry associated with the application; transition of the application between a foreground mode and a background mode.

The application status may comprise a determination of whether an application is running on the central processor which requires application specific hardware audio effects.

The hardware control signal may comprise an instruction to apply a default set of the first hardware audio effects if it is determined that no application is running on the central processor which requires application specific hardware audio effects. The hardware control signal may comprise an instruction to apply an application specific set of the first hardware audio effects if it is determined that the application requires application specific hardware audio effects.

The central processor may be further configured to: determine a type of audio content in the first audio signal based on the application status. The type of audio may be selected from one or more of: media content, movie content, game chat content, speech content, communications content, alerts content, sound effects content, game media content, game effects content, sensor content, audible content, and ultrasonic content.

The first hardware audio effects may comprise one or more of: baseline speaker protection; rattle distortion reduction; distortion limiting; crossover filtering; spatial processing; equalization; virtual and/or dynamic bass enhancement; dynamic range compression.

The system may further comprise a communications channel between the main circuitry and the audio processing circuitry.

The system may further comprise the output audio transducer.

The audio processing circuitry may comprise an amplifier configured to amplify the first hardware processed audio signal to obtain the output audio signal.

The first hardware processed audio signal may be a digital signal. The audio processing circuitry may comprise a digital-to-analog converter (DAC) for converting the first hardware processed audio signal to the analog domain.

The audio processing circuitry may comprise an audio CODEC configured to generate the output audio signal.

The audio processing circuitry may comprise a digital signal processor (DSP) configured to apply the hardware audio effects.

The main circuitry may be integrated into a first integrated circuit (IC). The audio processing circuitry may be integrated into a second IC separate from the first IC.

The controller may be integrated into the second IC.

According to another aspect of the disclosure, there is provided a system, comprising: main circuitry, comprising: a central processor; memory comprising software instructions which when executed by the central processor cause the central processor to: detect a status of an application to be executed on the central processor; output a first media signal; output a hardware control signal in dependence on the status; graphics processing circuitry configured to: receive the first media signal; apply first hardware graphics effects to the first media signal to generate a first hardware processed media signal; and output an output media signal derived from the first hardware processed media signal; and a controller configured to dynamically adjust the first hardware graphics effects applied to the first media signal based on the hardware control signal.

According to another aspect of the disclosure, there is provided a system, comprising: main circuitry, comprising: a central processor; memory comprising software instructions which when executed by the central processor cause the central processor to: determine a physical configuration of the system; output a first audio signal; output a hardware control signal in dependence on the physical configuration; audio processing circuitry configured to: receive the first audio signal; apply first hardware audio effects to the first audio signal to generate a first hardware processed audio signal; and output an output audio signal derived from the first hardware processed audio signal to an output audio transducer; and a controller configured to dynamically adjust the first hardware audio effects applied to the first audio signal based on the hardware control signal.

Determining the physical configuration of the system may comprise receiving a configuration signal from one or more sensors of the system; and determining the physical configuration based on the configuration signal. The one or more sensors may comprise an accelerometer and/or a hinge sensor.

The system may comprise a personal computer, and the physical configuration of the system may comprise an orientation of a screen relative to a main body of the personal computer. The physical configuration may, for example, comprise one of: a clamshell configuration; a laptop configuration; a tent configuration; and a tablet configuration.

According to another aspect of the disclosure, there is provided an electronic device, comprising the system described above. The electronic device may comprise one of a personal computing device, a laptop computer, a tablet computer, a games console, a remote-control device, a home automation controller or a domestic appliance, a toy, a robot, an audio player, a video player, or a mobile telephone, and a smartphone.

According to another aspect of the disclosure, there is provided a method implemented on a central processor for controlling peripheral audio processing circuitry, the method comprising: outputting a first audio signal to the audio processing circuitry; detecting a status of an application to be executed on the central processor; in a kernel mode, outputting a hardware control signal to the audio processing circuitry, the hardware control signal for adjusting first hardware audio effects applied to the first audio signal by audio processing circuitry based on the status of the application.

Detection of the status of the application to be executed may be performed in the kernel mode by a device driver, or in user mode, or by a user-mode driver or an application running on the central processor.

Throughout this specification the word “comprises”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 is schematic diagram of a known personal computer (PC) system;

FIG. 2 an example architecture of the PC system of FIG. 1;

FIGS. 3 and 4 are flow diagrams of processes implemented by an application detection module implemented by the PC of FIG. 1;

FIG. 5 an example architecture of the PC system of FIG. 1; and

FIG. 6 an example architecture of the PC system of FIG. 1

### DESCRIPTION OF EMBODIMENTS

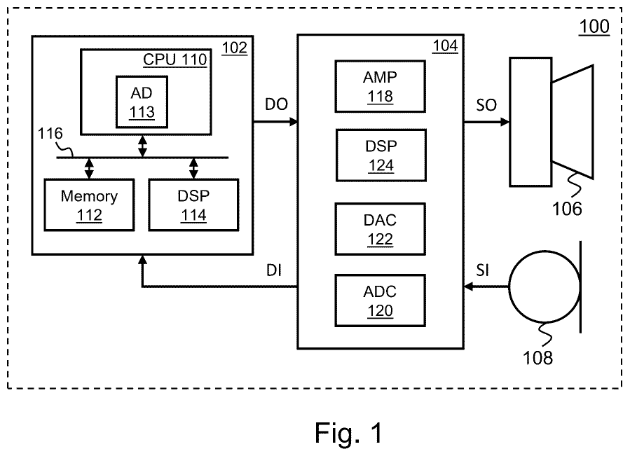

FIG. 1 is a schematic diagram of a personal computer (PC) 100. For clarity of explanation, only components of the PC 100 relevant to the present disclosure are shown. The PC 100 may comprise additional components (not shown), as is known in the art.

The PC 100 comprises main circuitry 102, peripheral audio processing circuitry 104, an output audio transducer 106 (e.g. a speaker), and optionally an input audio transducer 108 (e.g. a microphone).

The main circuitry 102 may be integrated onto a single integrated circuit (IC) or system on chip (SoC). The peripheral audio processing circuitry 104 may be integrated onto a single IC or multiple ICs. The main circuitry 102 may be provided on a separate IC to the one or more ICs integrating the peripheral audio processing circuitry 104.

The main circuitry 102 comprises a central processing unit (CPU) 110, a memory 112, and optionally a digital signal processor (DSP) 114, which may each communicate with one another via a bus 116. The memory 112 may store instructions which, when executed by the CPU 110 may cause the CPU 110 to perform one or more processes, as will be described in more detail below. The CPU 110 may be configured to run one or more audio processing objects (APOs) which may also be stored in the memory 112. Thus, the CPU 110 may be configured to process audio signals received from the input audio transducer 108. The CPU 110 may generate audio signals DO which may be stored in the memory 112 and/or transmitted to the peripheral audio processing circuitry 104. The CPU 110 may also process input audio signals DI received from the peripheral audio processing circuitry 104. The DSP 114 may be integrated on to the same system on chip (SoC) as the CPU 110. The CPU 110 may implement a application detection (AD) module 113 as will be discussed in more detail below. In this arrangement, the AD module 113 may be implemented by one or more software drivers executed on the CPU. Such driver may be implemented at the user level, the kernel level, or a combination of both. In a variation of the arrangement shown in FIG. 1, the AD module 113 may be implemented on the DSP 114. Thus, while in the following description reference is made to the AD module 113 executing on the CPU 110, the present disclosure is not so limited and the AD module 113 may be implemented on the DSP 114, on the peripheral audio processing circuitry 104, or on a controller (not shown) separate and distinct from the main circuitry 102 and the peripheral audio processing circuitry 104, or on any combination of the CPU 110, the DSP 114, the peripheral audio processing circuitry 104, and the separate and distinct controller.

As noted above, the main circuitry 102 is configured to communicate with the peripheral audio processing circuitry 104, for example using a communications bus (not shown). The main circuitry may be configured to output one or more audio signals DO to the peripheral audio processing circuitry 104 and receive one or more audio signals DI from the peripheral audio processing circuitry 104.

The peripheral audio processing circuitry 104 may comprise one or more of an amplifier 118, a digital-to-analog converter (DAC) 122, an analog-to-digital converter (ADC) 120, and a digital signal processor (DSP) 124. For example, where the peripheral audio processing circuitry 104 is configured to process signals for output to the output audio transducer 106, the peripheral audio circuitry 104 may comprise the DAC 122 for converting digital signals, such as the digital audio signals DO output from the main circuitry 102 to the (analog) output signal SO. In another example, the peripheral audio processing circuitry 104 may comprise the amplifier 118 to amplify signals for output to the output audio transducer 106. In another example, where the peripheral audio processing circuitry 104 is configured to process signals from the input audio transducer 108, the peripheral audio processing circuitry 104 may comprise the ADC 120 for converting analog signals from the input audio transducer 108 to digital signals. In another example, where the input audio transducer 108 is a digital microphone outputting digital audio signals, the peripheral audio processing circuitry 104 may not comprise the ADC 120. In another example, the DSP 124 may be provided to process audio signals to be provided to the output audio transducer 106 and/or process audio signals received from the input audio transducer 108. In some embodiments, separate DSPs may be provided for processing of signals proceeding towards the output audio transducer 106 versus those proceeding away from the input audio transducer 108.

The peripheral audio processing circuitry 104 may be provided on a single IC. Alternatively, the peripheral audio processing circuitry 104 may be provided on multiple ICs. For example, components of the peripheral audio processing circuitry 104 for processing signals for the output audio transducer 106 may be provided on a separate IC to components of the peripheral audio processing circuitry 104 for processing signals output by the input audio transducer 108.

When provided, the DAC 122 may be configured to convert processed audio signal(s) DO to an analog audio signal SO to be output to the output audio transducer 106. When provided, the amplifier 118 may be configured to amplify the processed audio signal DO for output as the output signal SO. Amplification may be performed in the digital domain (before conversion by the DAC 122) or in the analog domain (after conversion by the DAC 122). The output signal SO may then be then output to the output audio transducer 106 to be played back to the user.

When provided, the ADC 120 may be configured to convert the input signal SI to the digital input signal DI to be output to the main circuitry 102. When provided, the amplifier 118 may be configured to amplify the input signal SI for output as the digital input signal DI. Amplification may be performed in the analog domain (before conversion by the ADC 120) or in the digital domain (after conversion by the ADC 120). The output signal SO may then be then output to the transducer 106 to be played back to a user.

Various drivers may be provided in the form of instructions stored in the memory 112. For example, an audio streaming driver may be provided to set up audio streams through the DSP 114. A streaming driver extension may also be provided to expand the streaming capability of the PC 100. The streaming driver extension may indicate to the streaming driver how modules of the DSP 114 are interconnected. In another example, an offload engine driver may be provided to process offloaded audio streams. Offloaded audio streams are those audio streams which are processed by components other than the CPU 110, such as by the DSP 114. An offload engine driver extension may be provided to further expand the offload capability of PC 100. The offload engine driver extension may indicate where to find particular DSP modules (firmware) image files for loading into the DSP 114. Each DSP module image file may define one or more audio effects (or signal processing steps) which may be loaded onto the DSP 114.

Embodiments of the present disclosure provide novel techniques for handling adaptive control of the audio processing circuitry 104 in dependence on one or more properties of an application process executing on the central processor 110. In particular, embodiments implement application detection in a device driver which is then used to adjust hardware settings. By implementing application detection at the driver level, the requirement for APOs for application detection can be avoided. In doing so, the size of so-called “bloatware” can be reduced since such APO solutions are complicated and require additional application or services to operates. In addition, processing requirements may be reduced, leading to reduced power consumption and improved efficiency. In addition, the vulnerability of audio processing to APO installation can be significantly ameliorated. In addition, user data pertaining to application use may be secured, particularly the application detection is implemented at the kernel level. In addition, since drivers implementing application detection are also responsible for controlling audio processing (in dependence on application detection), the likelihood of their removal by IT departments is significantly reduced, ensuring that functionality of audio processing systems is retained.

Various implementation details will now be described in relation to application detection. Application detection refers to the identification of specific application processes running in an operating system in addition to detection of signals associated with those applications. In the context of audio processing, application detection may comprise detecting certain types of application and audio signals associated with or expected to be generated by those applications, such that audio processing can be tailored to such applications. Example application types include but are not limited to media applications which may generate media type audio; gaming applications which may generate game, music/media, and in-game communication type audio; and voice over internet protocol (VoIP) applications which may generate speech type audio.

Embodiments are not limited to implementing application detection at the driver level. Additionally, or alternatively, other detection functionality may be implemented at the driver level in a similar manner to that described herein. For example, posture detection may be implemented using device driver.

Posture detection may comprise detection of a physical configuration of the PC 100. The physical configuration of the PC 100 may affect how sound is projected from the one or more output audio transducers 106 or received at the one or more input audio transducers 108. Certain configurations may obstruct acoustic signals and may therefore require compensation for optimal audio performance, particularly where the PC 100 is implemented as a laptop or tablet computer. For example, the posture may relate to a configuration of a lid portion of the PC 100 (e.g. comprising the display) relative to a base portion of the PC 100 (particularly when implemented as a laptop). The display portion may rotate relative to the base portion about one or more axes as is known in the art. As such, the PC 100 may be operable in a “clamshell” or “laptop” configuration, a “tablet” configuration in which the lid portion is closed relative to the base portion such that the display faces away from the base portion, and a so-called “tent” configuration similar to a “clamshell” configuration apart from that the display faces away from the base portion. The meaning of these terms is known in the art and so will not be described in more detail here.

A determination of posture may be achieved in any suitable way. For example, one or more accelerometer(s) and/or hinge sensor(s) of the PC 100 may be queried to determine angle and/or orientation of the lid portion relative to the base portion. By implementing posture detection at the driver level, improved and more direct access to such hardware may be improved.

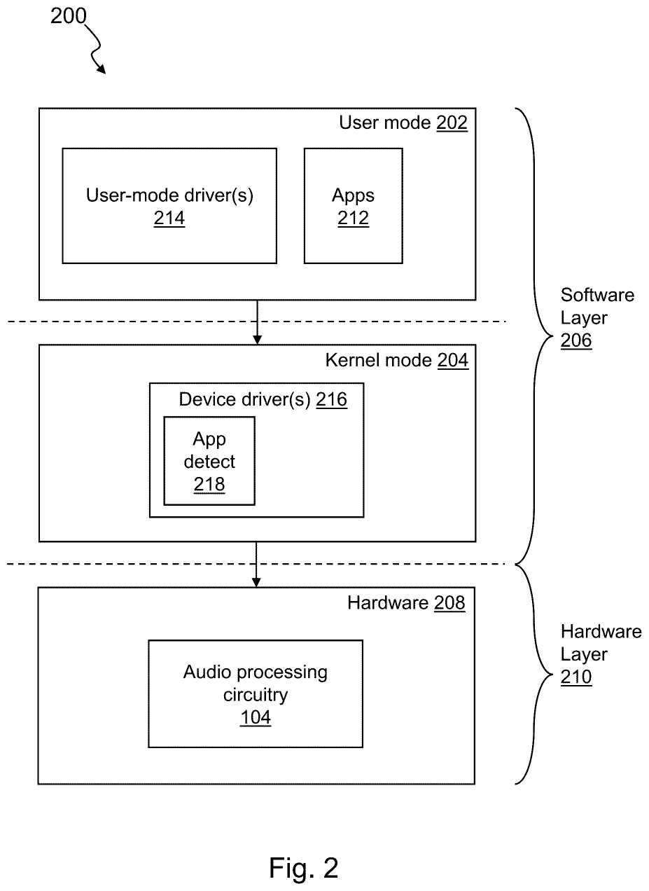

Application or posture (or physical configuration) detection at the driver level may be implemented using a user-mode device driver or a kernel-mode device driver. FIGS. 2 to 4 describe driver level implementation options for application detection but may be extended to implementation of other detection processes, such as posture detection.

FIG. 2 is a schematic diagram illustrating an example architecture 200 according to embodiments of the present disclosure, including communication between user-mode components 202 and kernel-mode components 204 operating in a software layer 206 of an operating system executing on the central processor 110 of the PC 100, and hardware components 208 implemented in a hardware layer 210 of the PC 100.

User-mode components 202 may comprise one or more applications of interest 212 and one or more user-mode drivers 214.

The one or more applications of interest 212 may comprise various types of applications, including but not limited to media applications, movie applications, game applications, and communications applications (e.g. voice over internet protocol (VOIP)). Each type of application may be configured to generate one or more audio streams having a particular stream type. Such stream types may include but are not limited to media content, movie content, game chat content, speech content, communications content, alerts content, sound effects content, game media content, game effects content, sensor content, audible content, and ultrasonic content.

The one or more user-mode drivers 214 are executed in a user-mode of the operating system. Each application of interest 212 and user-mode driver 214 is therefore provided with a private virtual address space and a private handle table. Since each virtual address space is private, one application or driver cannot modify another application or driver's data. Each application or driver runs in isolation, ensuring that if one crashes, it doesn't affect other applications, drivers, or the operating system. The virtual address space of the user-mode is also limited. A process running in user-mode cannot access virtual addresses that are reserved for the operating system. Limiting the virtual address space of a user-mode application prevents the application from modifying or damaging critical operating system data. Such user-mode operation is known in the art and so will not be described further.

The kernel-mode components 204 may comprise one or more device drivers 216. Since the device drivers 216 are running in the kernel mode, they share a single virtual address space with all drivers and processes operating in the kernel mode. As a result, each device driver 216 is not isolated from other kernel-mode drivers or the operating system. A disadvantage of this is that if one of the device drivers 216 mistakenly writes to the wrong virtual address, such action could compromise data belonging to the operating system or another driver. If one of the device drivers 216 crashes, it may cause the entire operating system to crash. An advantage of operating in the kernel mode, is that the devices drivers 216 have greater access to the hardware components 208 and resources of the PC 100 relative to user-mode drivers 214. The device driver(s) 216 may be configured to control hardware components 208, such as the audio processing circuitry 104.

Thus, in the example shown in FIG. 2, an AD module 218 is provided in the one or more device drivers 216. The AD module 218 is configured to detect one or more characteristics of application(s) of interest 212 running in user-mode and, in response, directly transmit control signals to the audio processing circuitry 104 to update or adjust one or more settings of the audio processing circuitry 104. Kernel mode operation of the device drivers 216 enables such drivers to directly control hardware such as the audio processing circuitry 104. In other words, the AD module 218 can directly transfer commands to the audio processing circuitry 104 from the kernel. the Operation of the AD module 218 will be described in more detail below.

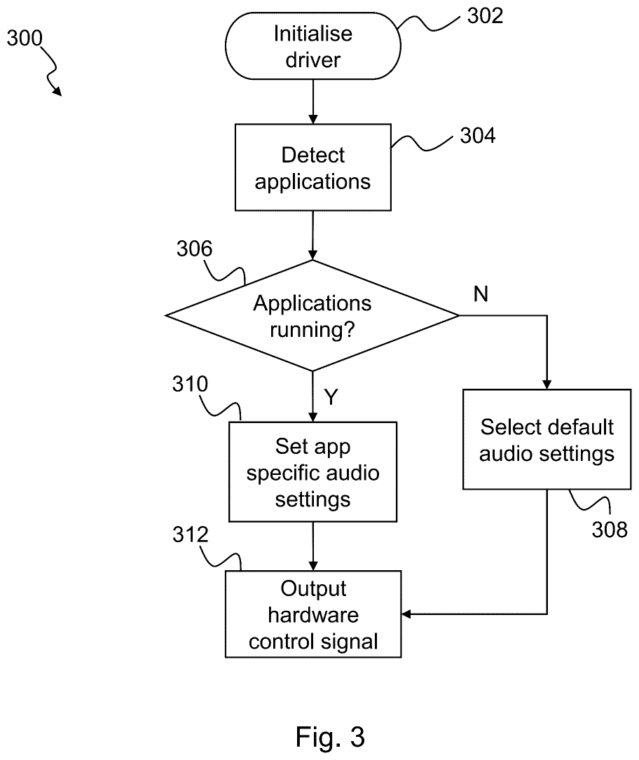

FIG. 3 is a flow diagram showing an example process 300 implemented by the application detection (AD) module 218.

At step 302, the AD module 218 is initialised, for example by loading of the device driver 216 comprising the AD module 218. Default and application specific audio hardware settings may be loaded into the memory 112 during initialisation of the driver 216.

After initialisation, at step 304, the AD module 218 may detect applications of interest 212 running on the main circuitry 102, such as on the central processor 110, or the DSP 114. Such applications of interest 212 may be those types of application which are expected to generate audio signals, such that audio processing can be tailored to such applications. Examples of such applications are described above.

If at step 306 it is determined that no applications or interest 212 are running (or no applications related to audio hardware configuration are running), then the process 300 proceeds to step 308 in which one or more default audio settings are selected.

If at step 306 it is determined that one or more applications of interest 212 requiring a specific audio hardware configuration are running, then the process 300 proceeds to step 310 in which one or more application specific audio hardware settings are selected.

In some scenarios, multiple applications of interest 212 may be running that may each require a different set of app specific audio settings. This scenario may be handled in various ways. For example, a priority order of applications of interest 212 may be defined and stored in memory, such as the memory 112 or in a registry of the PC 100. The priority order may set a hierarchy upon which to select specific audio hardware settings. There may be situations where a certain tuning can be applied to multiple applications of interest. So for example, if only application A is running, a first set of audio settings may be applied; if only application B is running, a second set of audio setting may be applied; and if applications A and B are running concurrently, a third set of audio settings may be applied. The first, second and third settings may all be different. For example, the third set of audio setting may reach a compromise between first and second settings, but which supports audio for both applications A and B. In another example, multiple audio signals DO may be provided to the peripheral audio processing circuitry 104, each comprising a separate audio stream from each of applications A and B. In which case, audio processing settings may be applied independently to each stream. Such implementation may avoid or reduce the requirement to prioritize one application or set of application over another.

From steps 308 and 310, the process 300 proceeds to step 312 in which the selected audio hardware settings are output to the audio processing circuitry 104 to update one or more audio processing settings of the audio processing circuitry 104.

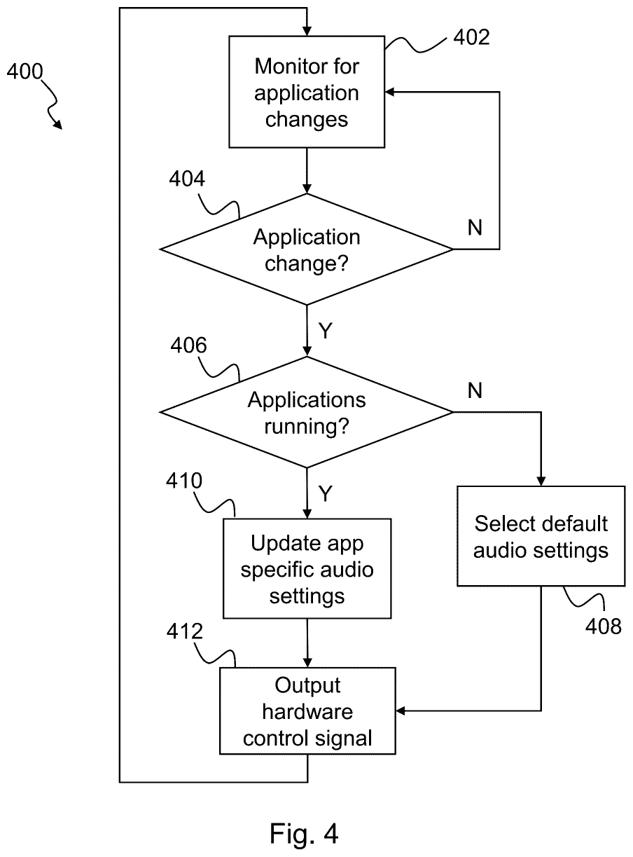

FIG. 4 is a flow diagram showing an example process 400 implemented by the AD module 218. The process 400 may be implemented in real-time after initialization of the AD module 218, for example, after the process 300 shown in FIG. 3 has been completed. At this stage, the AD module 218 may operate in a monitoring mode in which changes in status of applications of interest 212 running on the main circuitry 102 is monitored with audio hardware settings updated accordingly.

At step 402, the AD module 218 monitors for changes in applications of interest 212 running on the main circuitry 102. An application change may comprise the initialisation or termination of an application or interest, the creation or deletion of an application process, a change in system configuration, or a change in a characteristic of an audio stream generated or augmented by an application of interest, or the like. An application change may comprise the transition of an application of interest between running in the foreground and the background.

For example, system information may be retrieved by the AD module 218. For example, system information may comprise a mode of the PC 100, such as but not limited to a dark mode, a reading mode, a power-saving mode, a gaming mode, a communication mode and a speech mode.. Different modes may required different audio settings. For example, in a power-saving mode, it may be preferably to implement certain audio settings which improve power efficiency. For example, in a gaming mode, certain audio settings may be enhanced to create a more immersive gaming experience for a user of the PC 100. For example, in a dark or reading mode, it may be preferably to apply softer, warmer tuning to audio for a more c comfortable or relaxing experience. As such, the acquired system information may be combined with determinations of application status by the AD module 218 to determine audio settings to apply.

In another example, the AD module 218 may be configured to detect loading of applications (e.g. into the memory 112) for execution by the central processor 110. Loading and unloading of applications of interest 212 may indicate the opening or closing of applications by a user. For example, the AD module 218 may initialise a routine that registers a callback such that the AD module 218 is notified whenever an image (for example a DLL or EXE file) is loaded or mapped into the memory 112. An example of such a routine in the Microsoft (RTM) Windows (RTM) environment is the “PsSetLoadImageNotifyRoutineEx” routine.

In another example, the AD module may be configured to detect the creation or deletion of a process associated with an application. This may be of particular benefit where applications are running (and therefore loaded into the memory 112) but not producing any audio content. An example of this is a VoIP application running in the background. For such an application, a process may created on commencement of a VoIP call. Such a change in application status may call for updated application specific audio settings. To detect process creation or deletion, the AD module 218 may initialise a routine that adds a callback routine to, or removes it from, a list of routines to be called whenever a process is created or deleted. An example of such routine in the Microsoft (RTM) Windows (RTM) environment is the “PsSetCreateProcessNotifyRoutine” routine.

At step 404, if an application change is not detected, the process 400 returns to step 402 where the AD module 218 continues to monitor for changes in applications of interest 212. However, if an application change is detected, the process 400 proceeds to step 406 where a determination is made as to whether any applications are running at all. For example, if the detected application change comprises the termination of the only application requiring specific audio processing settings, then such a change will lead to there being no applications running that require specific audio processing settings. In which case, the process 400 proceeds to step 408, where default audio setting are selected.

If, at step 406, is it determined that applications requiring specific audio processing settings are running, then the process 400 proceeds to step 410 in which application specific audio settings are updated based on the application change observed by the AD module 218 at step 404.

The process 400 then proceeds to step 412 in which the selected audio hardware settings are output to the audio processing circuitry 104 to update one or more audio processing settings of the audio processing circuitry 104.

The process 400 may then proceed back to step 402 where the AD module 218 monitors for changes in applications of interest 212 running on the main circuitry 102.

Thus, the AD module 218 is configured to control operation of the audio processing circuitry 104 based on a characteristic of the one or more applications of interest 212 running on the main circuitry 102.

As noted above, application specific audio settings may be selected and applied to the audio processing circuitry 104. Such audio settings may comprise one or more of the following non-exhaustive list of audio processing effects: baseline speaker protection; rattle distortion reduction; distortion limiting; crossover filtering; spatial processing; equalization; virtual and/or dynamic bass enhancement, and dynamic range compression.

One or more of the above audio processing effects may be implemented based on a type of audio stream being generated by the applications of interest 212 being executed by the main circuitry 102. As noted above, such audio types include but are not limited to media content, movie content, game chat content, speech content, communications content, alerts content, sound effects content, game media content, game effects content, sensor content, audible content, and ultrasonic content.

As an example, equalisation may be adjusted based on a type of applications of interest 212 running on the main circuitry 102. For a media application outputting media content, the application specific audio settings may include equalisation settings to increase based and/or tune equalisation for balance. On the contrary, for a VOIP application outputting speech content, the application specific audio settings may include equalisation settings to decrease bass and emphasis frequencies in the range of human speech. In doing so, the audio settings controlled to emphasize voice when audio streams being processed contain speech (i.e. during VoIP sessions), whilst reducing bass which could make speech sound “muddy”.

As another example, dynamic range compression (DRC) may be adjusted based on a type of application of interest 212 running on the main circuitry 102. DRC is a signal processing technique that reduces the difference between loudest and quietest parts of an audio signal by attenuating loud components and amplifying quieter components. This technique may improve audibility of speech in the presence of loud sound effects and also reduce the need to adjust the volume significantly when listening at different levels (such is the case in VoIP calls). As such, DRC may be applied when the AD module 218 detects that a VoIP application running or a call in progress (e.g. based on a process or system status). Media content, on the other hand, often requires more dynamics to sound “lively”, whilst sacrificing some dynamic may achieve a higher overall volume. Accordingly, a different configuration of DRC may be applied for applications outputting audio streams with media content.

In the example described above, the AD module 218 is implemented at the driver level in kernel mode. However, in other examples, the AD module 218 may be implemented in user mode.

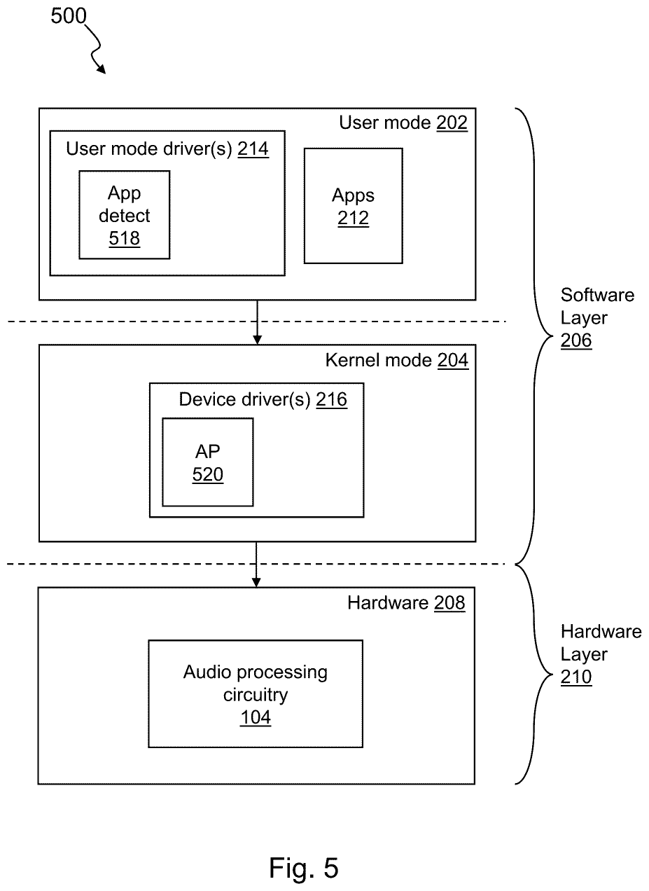

FIG. 5 is a schematic diagram illustrating an example architecture 500 according to embodiments of the present disclosure which is a variation of the architecture 200 shown in FIG. 2, differing only in that the kernel mode AD module 218 is replaced with a user mode AD module 518 implemented as part of a user mode driver 214. Whilst implemented in user mode as opposed to in kernel mode, the AD module 218 operates largely as described with reference to FIGS. 3 and 4. However, since the AD module 518 is implemented as a user mode driver 214, the AD module 218 does not have direct control of the audio processing circuitry 104. To update hardware audio settings, the AD module 518 is configured to send medication commands to an audio processing (AP) device driver 520 operating in the kernel. The AP device driver 520 then transfers commands from the AD module 518 to the audio processing circuitry 104.

In a further example, instead of implementing application detection using a combination of user mode and kernel mode drivers, application detection may be implemented using an application detection software tool in combination with a kernel mode device driver.

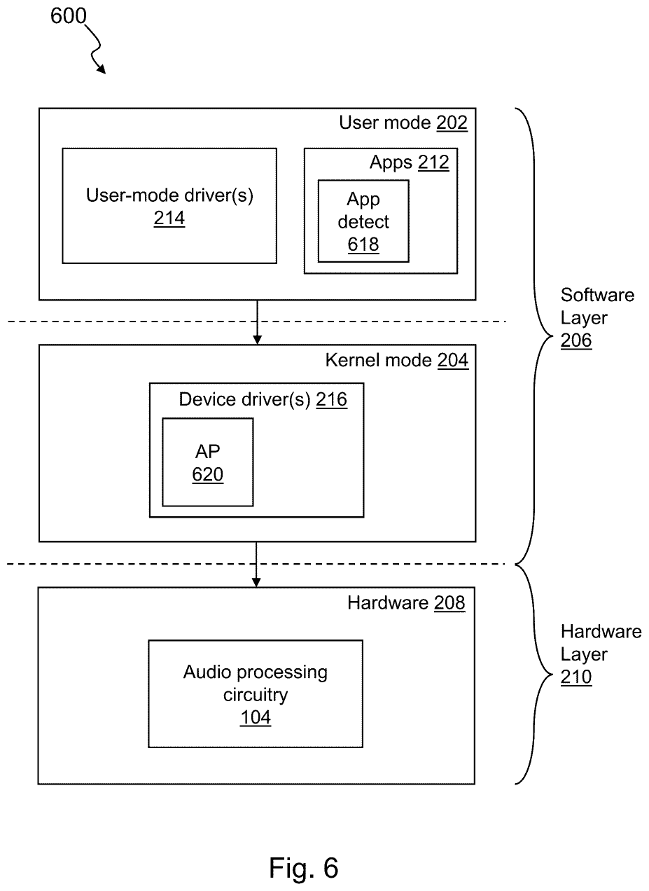

FIG. 6 is a schematic diagram illustrating an example architecture 600 according to embodiments of the present disclosure which is a variation of the architecture 200 shown in FIG. 2, differing in that the kernel mode AD module 218 is replaced with a user mode AD application 618 implemented as an application in the user mode. By maintaining application detection functionality in the user mode applications space, the AD application 618 can easily capture user-mode behaviours. To update hardware audio settings, the AD application 618 may send hardware modification commands to an audio processing (AP) device driver 620 operating in the kernel, similar to the AP device driver 620 of the architecture 500 of FIG. 5. The AP device driver 620 then transfers commands from the AD application 618 to the audio processing circuitry 104. Thus, the user mode AD application 618 operates as a companion to the AP device driver 620 and may therefore be referred to as a device drive application which runs in user mode. The user mode AD application 618 may be installed as part of a driver package which includes the AP device driver 620.

As a further variation of the architectures 200, 500, 600 described above, application detection functionality may be provided with two or more of a user mode driver, a kernel mode driver, and an application running in user mode.

There may be several advantages to splitting application detection and hardware control between an application running in user-mode and a device driver in the kernel. Firstly, the benefits of having access to user-mode behaviour can be realised with the presence application software at the user mode or a user mode driver implementing application detection. In addition, baseline functionality of application detection can be maintained in the kernel (e.g. by the AP device driver 620) such that baseline application detection and management is provided regardless of whether the AD application 618 is removed (for example by a system administrator). Baseline functionality may also be maintained by a user mode driver implementing application detection, although it will be appreciated that user mode drivers may be easier to remove than kernel mode drivers without causing serious malfunction of the PC 100.

In addition to the above, it will be appreciated that some user behaviour cannot be determined based only on kernel-based application detection. For example, where the PC 100 is used by multiple users, multiple application spaces may be provided (which can be monitored at the application level). However, user-mode and kernel mode drivers are shared by all users of the system. In such circumstances, it may be difficult to ascertain by a driver which application is running in the background (e.g. as part of a user account that isn't currently using the PC 100), and which application is running as part of the user's account who is currently using the PC 100.

Whilst embodiments herein are described with reference to controlling audio processing circuitry and hardware audio effects, the present disclosure is not so limited. For example, the systems and methods described herein may be extended to the control of graphics processing. Thus, the embodiments described above may be modified by the addition of graphics processing circuitry in place of or in addition to the audio processing circuitry. Main circuitry may then be configured to dynamically adjust first hardware graphics effects applied to a video signal based on a status of an application to be executed on the central processor.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A system, comprising:
main circuitry, comprising:
a central processor;
memory comprising software instructions which when executed by the central processor cause the central processor to:
detect a status of an application to be executed on the central processor;
output a first audio signal;
output a hardware control signal in dependence on the status;
audio processing circuitry configured to:
receive the first audio signal;
apply first hardware audio effects to the first audio signal to generate a first hardware processed audio signal; and
output an output audio signal derived from the first hardware processed audio signal to an output audio transducer; and
a controller configured to dynamically adjust the first hardware audio effects applied to the first audio signal based on the hardware control signal.

2. The system of claim 1, wherein the controller comprises a software driver executed on the central processor.

3. The system of claim 1, wherein the controller is implemented in hardware by the audio processing circuitry.

4. The system of claim 1, wherein detecting the status of the application is performed by a driver executed by the central processor.

5. The system of claim 4, wherein the driver is a kernel mode device driver executed in an operating system kernel.

6. The system of claim 1, wherein the status of the application comprises one or more of:
a. Loading or unloading of the application into the memory;
b. Creation or deletion of an application process associated with the application; and
c. One or more settings of the main circuitry associated with the application.

7. The system of claim 1, wherein the application status comprises a determination of whether an application is running on the central processor which requires application specific hardware audio effects.

8. The system of claim 7, wherein the hardware control signal comprises one or more of:
an instruction to apply a default set of the first hardware audio effects if it is determined that no application is running on the central processor which requires application specific hardware audio effects; and
an instruction to apply an application specific set of the first hardware audio effects if it is determined that the application requires application specific hardware audio effects.

9. (canceled)

10. The system of claim 1, wherein the central processor is further configured to:
determine a type of audio content in the first audio signal based on the application status.

11. The system of claim 10, the type of audio is selected from one or more of: media content, movie content, game chat content, speech content, communications content, alerts content, sound effects content, game media content, game effects content, sensor content, audible content, and ultrasonic content.

12. The system of claim 1, wherein the first hardware audio effects comprise one or more of:
a. baseline speaker protection;
b. rattle distortion reduction;
c. distortion limiting;
d. crossover filtering;
e. spatial processing;
f. equalization;
g. virtual and/or dynamic bass enhancement;
h. dynamic range compression.

13-14. (canceled)

15. The system of claim 1, wherein the audio processing circuitry comprises one or more of:
an amplifier configured to amplify the first hardware processed audio signal to obtain the output audio signal;
a digital-to-analog converter (DAC) for converting the first hardware processed audio signal to the analog domain;
an audio CODEC configured to generate the output audio signal; and
a digital signal processor (DSP) configured to apply the hardware audio effects.

16-18. (canceled)

19. The system of claim 1, wherein the main circuitry is integrated into a first integrated circuit (IC), and wherein the audio processing circuitry is integrated into a second IC separate from the first IC.

20. The system of claim 19, wherein the controller is integrated into the second IC.

21. A system, comprising:
main circuitry, comprising:
a central processor;
memory comprising software instructions which when executed by the central processor cause the central processor to:
determine a physical configuration of the system;
output a first audio signal;
output a hardware control signal in dependence on the physical configuration;
audio processing circuitry configured to:
receive the first audio signal;
apply first hardware audio effects to the first audio signal to generate a first hardware processed audio signal; and
output an output audio signal derived from the first hardware processed audio signal to an output audio transducer; and
a controller configured to dynamically adjust the first hardware audio effects applied to the first audio signal based on the hardware control signal.

22. The system of claim 21, wherein determining the physical configuration of the system comprises:
receiving a configuration signal from one or more sensors of the system; and
determining the physical configuration based on the configuration signal;
wherein the one or more sensors comprises an accelerometer and/or a hinge sensor.

23. (canceled)

24. The system of claim 21, wherein the system comprises a personal computer, and wherein the physical configuration of the system comprises an orientation of a screen relative to a main body of the personal computer,
wherein the physical configuration comprises one of:
a clamshell configuration;
a laptop configuration;
a tent configuration; and
a tablet configuration.

25. (canceled)

26. An electronic device, comprising the system of claim 1.

27. The electronic device of claim 26, wherein the electronic device comprises one of a personal computing device, a laptop computer, a tablet computer, a games console, a remote control device, a home automation controller or a domestic appliance, a toy, a robot, an audio player, a video player, or a mobile telephone, and a smartphone.

28. A method implemented on a central processor for controlling peripheral audio processing circuitry, the method comprising:
outputting a first audio signal to the audio processing circuitry;
detecting a status of an application to be executed on the central processor;
in a kernel mode, outputting a hardware control signal to the audio processing circuitry, the hardware control signal for adjusting first hardware audio effects applied to the first audio signal by audio processing circuitry based on the status of the application.

29. The method of claim 28, wherein detection of the status of the application to be executed is performed in the kernel mode by a device driver.

30. The method of claim 28, wherein detection of the status of the application to be executed is performed in the user mode.

31. The method of claim 28, wherein detection of the status of the application to be executed is performed by a user-mode driver or an application running on the central processor.
